(19) United States
(12) Patent Application Publication
(10) Pub. No.: US 2024/0006135 A1
(43) Pub. Date: Jan. 4, 2024

(54) THIN-FILM ELECTRIC SWITCH

(71) Applicant: FLEEP TECHNOLOGIES S.R.L., Milano (IT)

(72) Inventors: Giorgio DELL'ERBA, Milano (IT); Andrea PERINOT, Milano (IT)

(21) Appl. No.: 18/039,320

(22) PCT Filed: Nov. 30, 2021
(86) PCT No.: PCT/IB2021/061123

§ 371 Date: May 30, 2023

(30) Foreign Application Priority Data
Nov. 30, 2020 (IT) 102020000029033

(51) Int. Cl. H01H 15/10; H01H 15/24

(52) U.S. Cl. CPC H01H 15/10; H01H 15/24

(57) ABSTRACT

A thin-film electric switch applicable to a surface of an electrical system having at least two electrical connections has a slider element having a flexible main body having an upper surface and a lower surface and a portion of conductive material, a first flexible sheet having an upper surface, a lower surface and a first through opening defining a housing for the flexible main body, a second flexible sheet having an upper surface and a lower surface, positioned on the first flexible sheet to at least partially overlap the first through opening and retain the flexible main body inside the first through opening. The slider element slides inside the first through opening assuming a first operating position in which the portion of conductive material connects the at least two electrical connections to each other and a second operating position in which the portion of conductive material does not connect the at least two electrical connections.

### FIELD OF THE INVENTION

The present invention relates to the field of printed and flexible electronics, in particular to a thin-film electric switch.

### BACKGROUND ART

Switch devices are known, even thin ones.

In order to ensure an optimal opening and closing of the respective electrical contact, such switch devices contain rigid parts within which the actuator, also rigid, of the electric switch is adapted to move.

Therefore, such a type of switch device has poor mechanical flexibility, due to the presence of several rigid parts which inevitably limit the flexibility of the entire device and the conformability thereof to a surface to which it could be applied.

Furthermore, such a type of switch device can require assembly costs which may even exceed the advantages deriving from the use of said switch devices.

Therefore, the need is strongly felt to have switch devices available which ensure high if not complete mechanical flexibility, low assembly costs and ease of integration with existing flexible electronic systems, with manufacturing techniques suitable for large-scale production volumes.

### SUMMARY

It is the object of the present invention to devise and provide a thin-film electric switch which allows to at least partially obviate the drawbacks mentioned above with reference to the background art and which, in particular, is capable of ensuring a high level if not total mechanical flexibility, has low assembly costs and which allows being easily integrated into existing flexible electronic systems with manufacturing techniques suitable for large-scale production volumes.

Such an object is achieved by a thin-film electric switch according to claim 1.

Advantageous embodiments of such an electric switch are the subject of the dependent claims.

### BRIEF DESCRIPTION OF THE DRAWINGS

Further features and advantages of the thin-film electric switch according to the invention will be apparent from the following description of preferred embodiments, given by way of indicative, non-limiting examples, with reference to the accompanying figures, in which:

FIGS. 1a and 1b show, respectively, a top view and a side view of a component of a thin-film electric switch in accordance with an embodiment of the invention;

FIGS. 2a and 2b show, respectively, a top view and a side view of a further component of a thin-film electric switch in accordance with an embodiment of the invention;

FIGS. 3a and 3b show, respectively, a top view and a side view of a further component of a thin-film electric switch in accordance with an embodiment of the invention;

FIG. 4 shows an exploded perspective view of a thin-film electric switch in accordance with an embodiment of the invention;

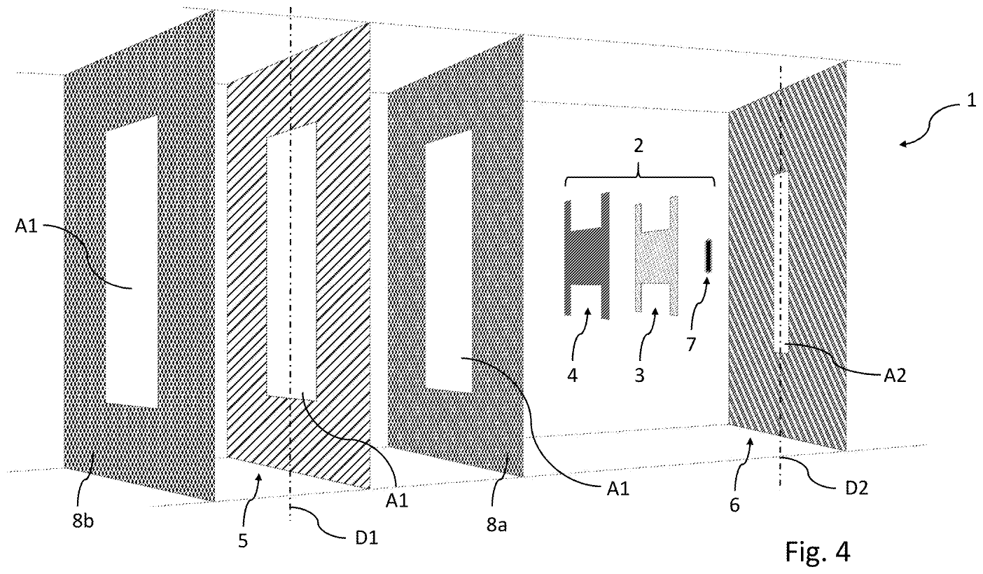

FIGS. 5a and 5b show, respectively, a top view and a side view of an assembly comprising the component of FIGS. 1a and 1b and the further component of FIGS. 2a and 2b;

FIGS. 6a and 6b show, respectively, a top view and a side view of an assembly comprising the component of FIGS. 1a and 1b and the further component of FIGS. 3a and 3b;

FIGS. 7a and 7b show, respectively, a top view and a side view of a thin-film electric switch comprising the component of FIGS. 1a and 1b, the further component of FIGS. 2a and 2b and the further component of FIGS. 3a and 3b;

FIG. 8a diagrammatically shows a top view of an electrical system in which a thin-film electric switch is used in accordance with an embodiment of the invention in a first operating position;

FIG. 8b diagrammatically shows a top view of the electrical system of FIG. 8b in which the thin-film electric switch is in a second operating position;

FIG. 9 shows a perspective view of a first component and a second component separated from each other which are couplable to form a thin-film electric switch in accordance with a further embodiment of the invention;

FIGS. 10a and 10b show, respectively, a side view and a top view of the components of FIG. 9 coupled together in which the first component is oriented in a first operating position;

FIGS. 11a and 11b show, respectively, a side view and a top view of the components of FIG. 9 coupled together in which the first component is oriented in a second operating position;

FIG. 12 shows a perspective view of the components of FIG. 9 coupled together as in FIGS. 11a and 11b in turn coupled to a further component to form a thin-film electric switch in accordance with an embodiment of the invention;

FIG. 13 shows a perspective view of a thin-film electric switch in accordance with a further embodiment of the invention;

FIGS. 14a, 14b and 14c show, respectively, a top perspective view, a bottom perspective view and a sectional side view of a component of the thin-film electric switch of FIG. 13, and

FIG. 15 diagrammatically shows a top view of a portion of an electrical system to which the component of FIGS. 14a, 14b and 14c is applied.

It is worth noting that equal or similar elements in the figures will be indicated by the same numeric or alphanumeric references.

### DESCRIPTION OF SOME PREFERRED EMBODIMENTS

With reference now to the aforesaid figures, the reference numeral 1 indicates a thin-film electric switch as a whole, hereinafter even simply an electric switch, in accordance with the present invention.

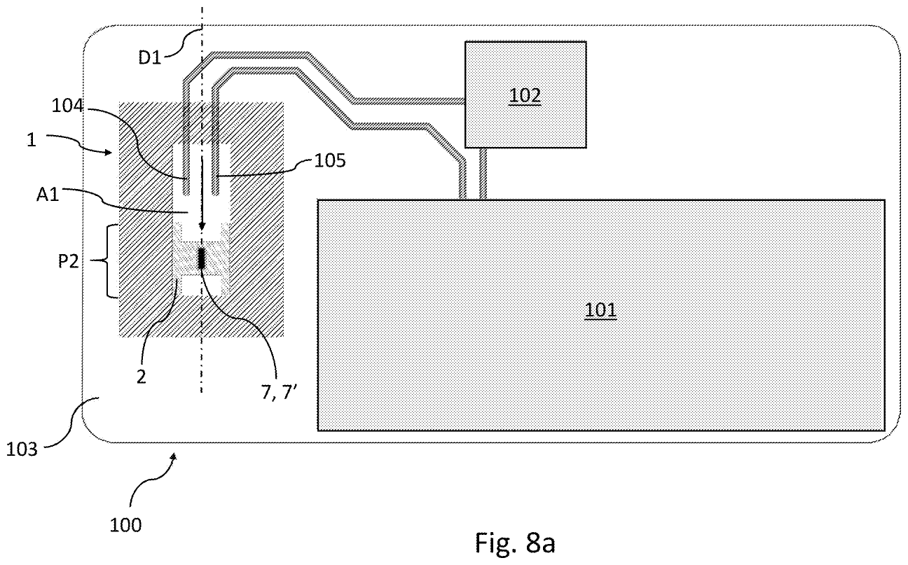

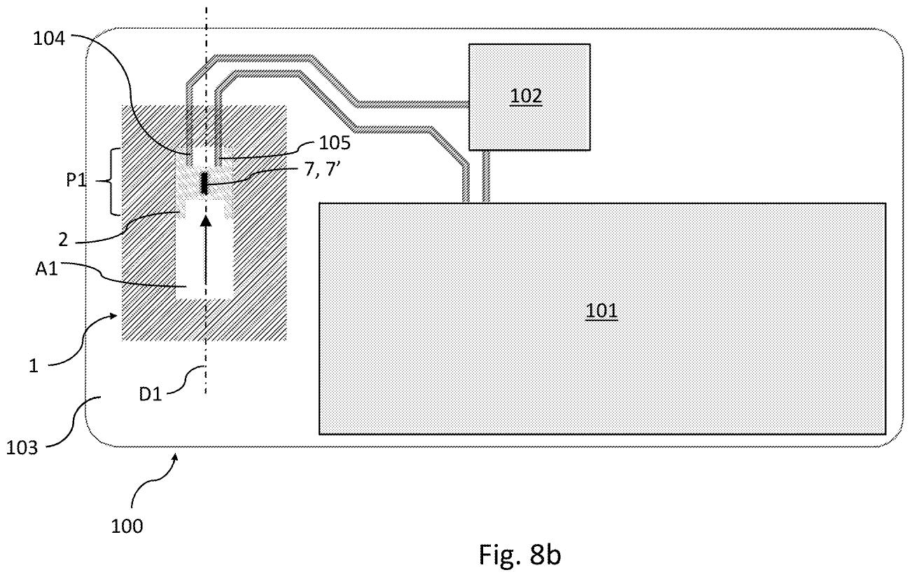

As shown in FIGS. 8a and 8b, the electric switch 1 can be applied to a surface 103 of an electrical system 100 comprising at least two electrical connections 104, 105 electrically connectable to each other.

The electrical connection between said at least two electrical connections 104, 105 obtainable by operating the electric switch 1 allows, for example, electrically connecting an electronic circuitry 101 with an electrical power supply module 102 of the electrical system 100.

Examples of an electrical system 100 can be:
an electronic application obtained with the use of “Flexible PCB”;
an electronic system obtained in the form of a “smart-label”;
a flexible electronic system integrated in objects subject to mechanical stresses, for example bending or curvature, such as items of clothing but not limited thereto;
an electronic system implemented in the form of a patch, such as a flexible system for monitoring biometric parameters to be applied to the body.

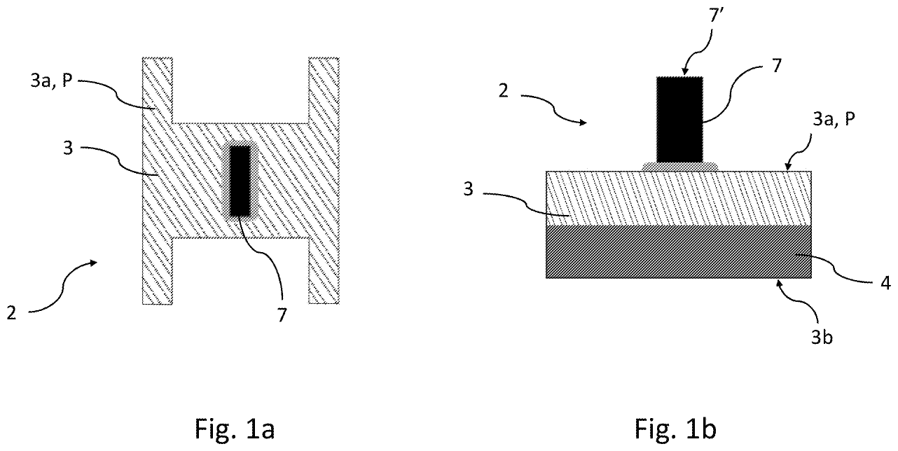

With reference now in particular to FIGS. 1a and 1b, the electric switch 1 comprises a slider element 2 comprising a flexible main body 3 of planar shape.

The flexible main body 3 comprises a respective upper surface 3a and a respective lower surface 3b.

The flexible main body 3 comprises at least one portion 4 of conductive material (e.g., metal) extending on the lower surface 3b.

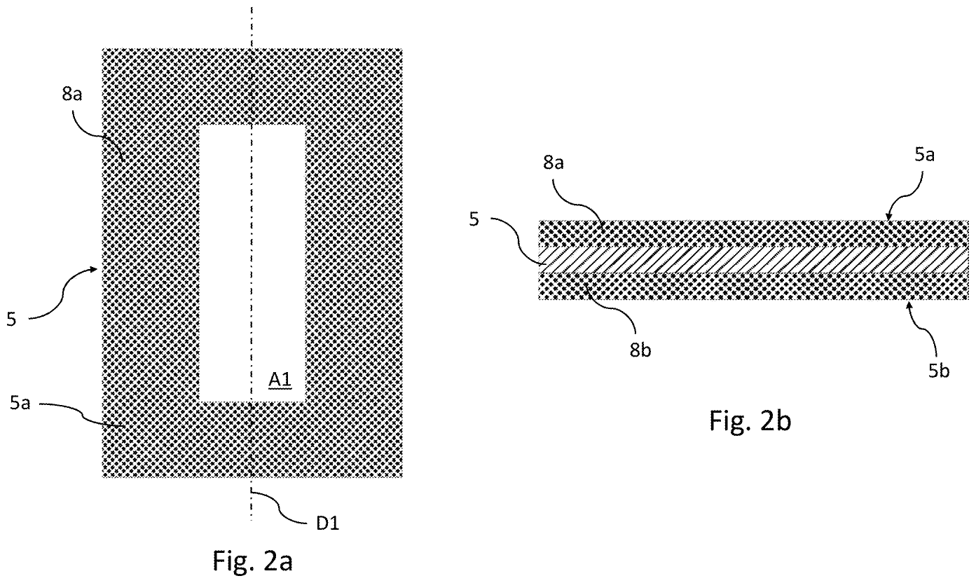

With reference now in particular to FIGS. 2a and 2b, the electric switch 1 further comprises a first flexible sheet 5 of planar shape having a respective upper surface 5a and a respective lower surface 5b.

The lower surface 5b of the first flexible sheet 5 is associable with the surface 103 of the electrical system 100 on which the electric switch 1 is applicable.

The first flexible sheet 5 can be made of plastic (for example, PET, PEN, Polyimide, Polycarbonate, and so on) or bioplastic (for example, polylactic acid) or paper or flexible material (for example, flexible glass).

The thickness of the first flexible sheet 5 can be any value in the range 1 micron-200 microns.

The first flexible sheet 5 comprises a first through opening A1 having a respective longitudinal extension direction D1.

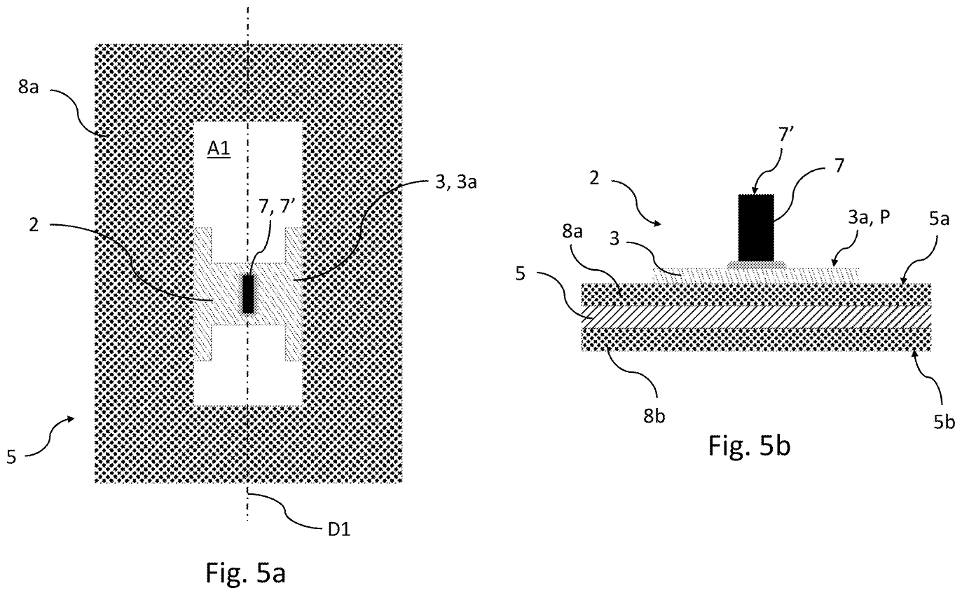

The first through opening A1 is adapted to define a housing for the flexible main body 3 of the slider element 2 having a shape such as to allow the sliding therein of the flexible main body 3 of the slider element 2 along the longitudinal extension direction D1 of said first through opening A1 (see, for example, FIG. 5a).

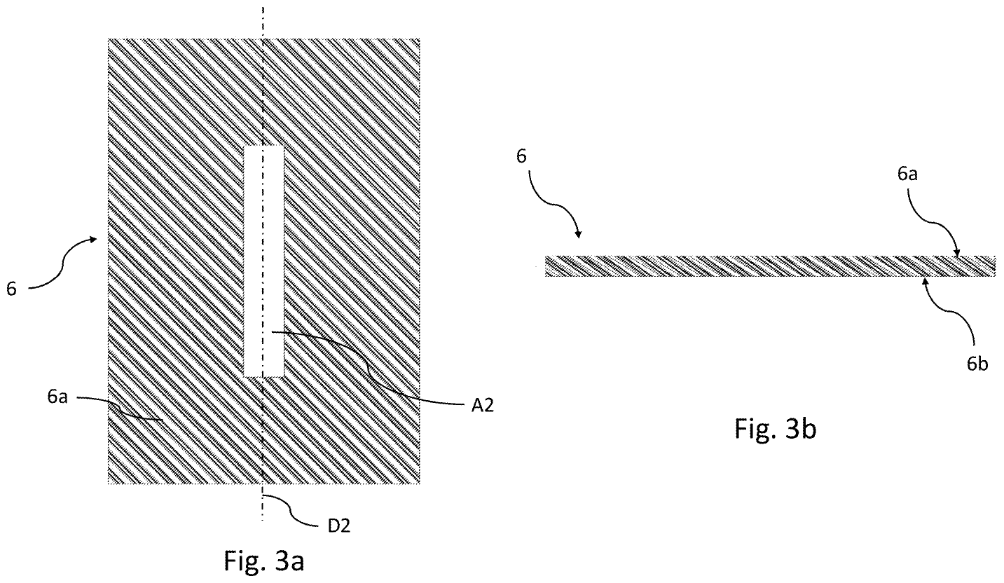

With reference now in particular to FIGS. 3a and 3b, the electric switch 1 further comprises a second flexible sheet 6 of planar shape having a respective upper surface 6a and a respective lower surface 6b.

The lower surface 6b of the second flexible sheet 6 is associable with the upper surface 5a of the first flexible sheet 5.

The second flexible sheet 6 can be made of plastic (for example, PET, PEN, Polyimide, Polycarbonate, and so on) or bioplastic (for example, polylactic acid) or paper or flexible material (for example, flexible glass).

The thickness of the second flexible sheet 6 can be any value in the range 1 micron-200 microns.

The second flexible sheet 6 comprises a second through opening A2 having a respective longitudinal extension direction D2 parallel to the longitudinal extension direction D1 of the first through opening A1.

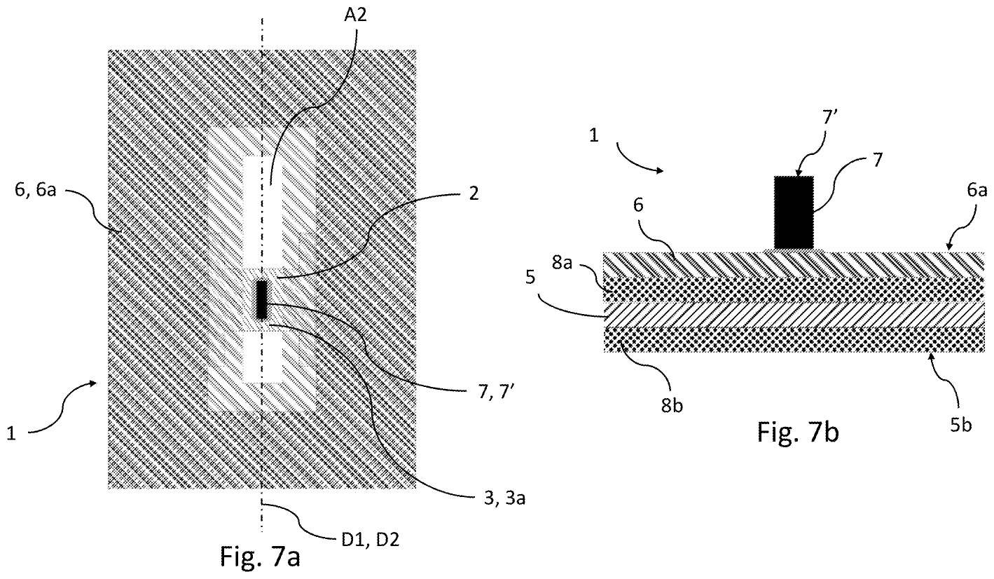

The second flexible sheet 6 is positioned on the first flexible sheet 5 so as to at least partially overlap the first through opening A1 so as to retain the flexible main body 3 of the slider element 2 inside the first through opening A1 between the surface 103 of the electrical system 100 on which the electric switch 1 is applicable and the lower surface 6b of the second flexible sheet 6 (see, for example, FIG. 7a).

The slider element 2 is adapted to slide inside the first through opening A1 of the first flexible sheet 5 along the longitudinal extension direction D1 of the first through opening A1 to assume at least a first operating position P1 in which the at least one portion 4 of conductive material of the flexible main body 3 of the slider element 2 connects the at least two electrically connectable electrical connections 104, 105 to each other present on the surface 103 of the electrical system 100 on which the electric switch 1 is applicable (FIG. 8b, switching-on or ON state of the electric switch 1) and at least a second operating position P2 in which the at least one portion 4 of conductive material of the flexible main body 3 of the slider element 2 does not electrically connect said at least two electrical connections 104, 105 to each other present on the surface 103 of the electrical system 100 on which the electric switch 1 is applicable (FIG. 8a, switching-off or OFF state of the electric switch 1).

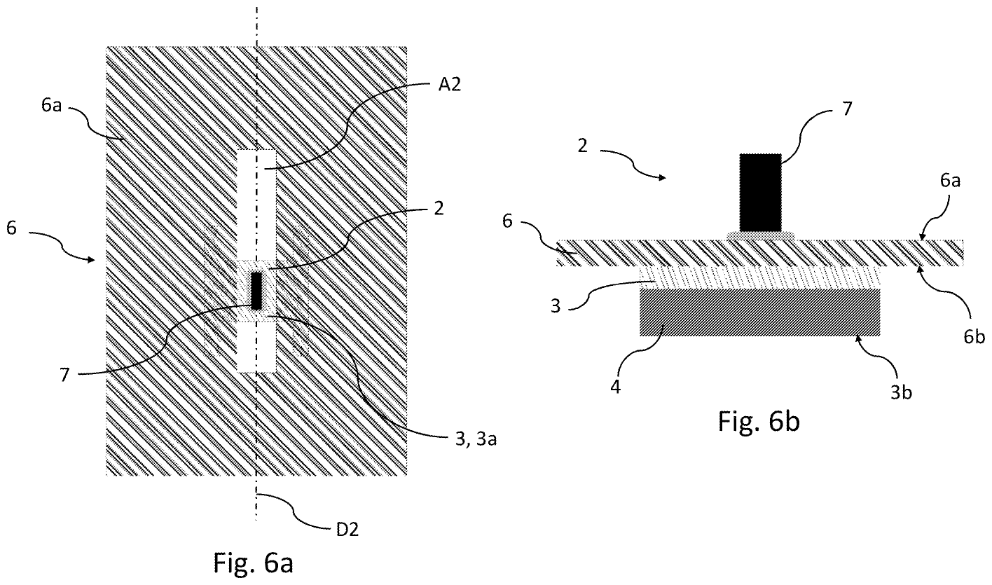

With reference in particular to FIGS. 5a, 6a, 7a, 8a and 8b, in accordance with an embodiment, in combination with the previous one, the flexible main body 3 of the slider element 2 has a shape such as to be housed inside the housing defined by the first through opening A1 of the first flexible sheet 5 and sliding along the longitudinal extension direction D1 of the first through opening A1 of the first flexible sheet 5.

In particular, transversely to the longitudinal extension direction D1 of the first opening A1 of the first flexible sheet 5, the flexible main body 3 of the slider element 2 has a width substantially equal to the width of the first through opening A1 of the first flexible sheet 5.

In accordance with an embodiment, in accordance with any one of those described above, the flexible main body 3 of the slider element 2 has a shape such as to be forced and oriented inside the housing defined by the first through opening A1 of the first flexible sheet 5.

For example, the flexible main body 3 of the slider element 2 can have an H-like shape (such as that shown in the figures) or a quadrangular or rectangular shape.

In accordance with an embodiment, in combination with any of those described above, shown in particular in FIGS. 1b, 5b, 6b, 7b and 9, the slider element 2 further comprises an actuator element 7 operatively connected to the flexible main body 3 extending therefrom along a direction substantially orthogonal to a reference plane P on which the flexible main body 3 extends, through the first through opening A1 of the first flexible sheet 5 and the second through opening A2 of the second flexible sheet 6 so that a free end 7′ of said actuator element 7 is accessible from the outside of the electric switch 1 to allow, by means of the actuation with the actuator element 7, the sliding of the slider element 2 along the longitudinal extension direction D1 of the first through opening A1 of the first flexible sheet 5.

It should be noted that the actuation of the actuator element 7 can occur for example manually by a user or automatically by a machine outside the electric switch 1 and/or the electrical system 100.

The actuator element 7 can be made of rigid plastic material or flexible plastic material or of elastomer-based material or of metallic material.

In some cases, the actuator element 7 can also simply be a drop of epoxy resin.

In an embodiment, in combination with the previous one, the actuator element 7 is distinct from the flexible main body 3 of the slider element 2.

In this embodiment, the actuator element 7 is operatively connected to the flexible main body 3 of the slider element 2 by gluing, for example using epoxy glue.

In accordance with a further embodiment, alternative to the previous one, the actuator element 7 is in one piece with the flexible main body 3 of the slider element 2.

In this embodiment, the actuator element 7 is obtained starting from the flexible main body 3 of the slider element 2 by cutting and bending.

In accordance with an embodiment, in combination with any of those described above, the flexible main body 3 is made of plastic material (for example, PET, PEN, Polyimide, Polycarbonate and so on) or bioplastic (for example, polylactic acid) or paper or flexible material (for example, flexible glass) and the at least one portion 4 of conductive material extending on the lower surface 3b is the lower surface 3b of the flexible main body 3.

The thickness of the flexible main body 3 can be in the range 1 micron-200 microns.

In accordance with a further embodiment, in combination with the previous one, the flexible main body 3 is made of plastic or bioplastic material (for example, polylactic acid) or paper or flexible material (for example, flexible glass) and the at least one portion 4 of conductive material extending on the lower surface 3b is a sheet of conductive material (for example, metal) attached (for example, laminated) to the lower surface 3b of the flexible main body 3.

In an embodiment, as an alternative to the previous ones, the flexible main body 3 is made of plastic or bioplastic material (for example, polylactic acid) or paper or flexible material (for example, flexible glass) and the at least one portion 4 of conductive material extending on the lower surface 3b is at least one area of conductive material distributed on the lower surface 3b of the flexible main body 3.

In a further embodiment, as an alternative to the previous ones, the entire flexible main body 3 of the slider element is made of conductive material.

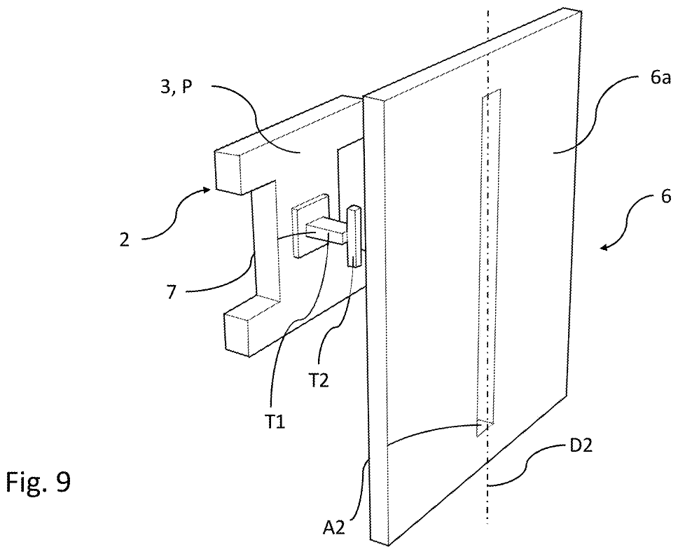

In accordance with an embodiment, shown in FIGS. 9, 10a, 10b, 11a, 11b and 12, in combination with any of those previously described in which the actuator element 7 of the slider element 2 is present, the actuator element 7 of the slider element 2 has a substantially T-like shape comprising a first segment T1 substantially orthogonal to the reference plane P on which the flexible main body 3 of the slider element 2 extends and a second segment T2, corresponding to the free end 7′ of the actuator element 7, transverse with respect to the first segment T1.

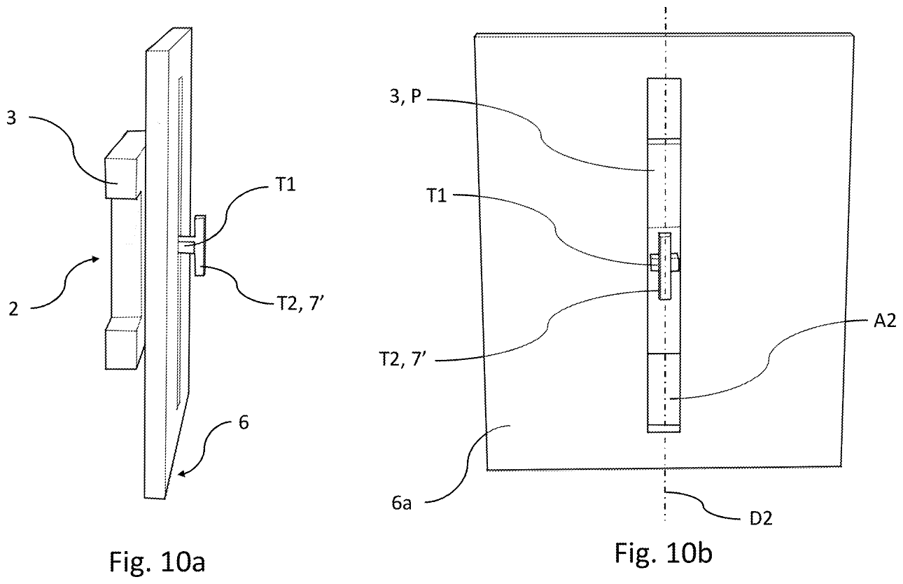

In this embodiment, the flexible main body 3 of the slider element 2 is orientable so that the second segment T2 of the actuator element 2 is parallel to the longitudinal extension direction D2 of the second through opening A2 of the second flexible sheet 6 to allow the passage of the second segment T2 of the actuator element 7 through the second through opening A2 of the second flexible sheet 6 (FIGS. 9, 10a, 10b).

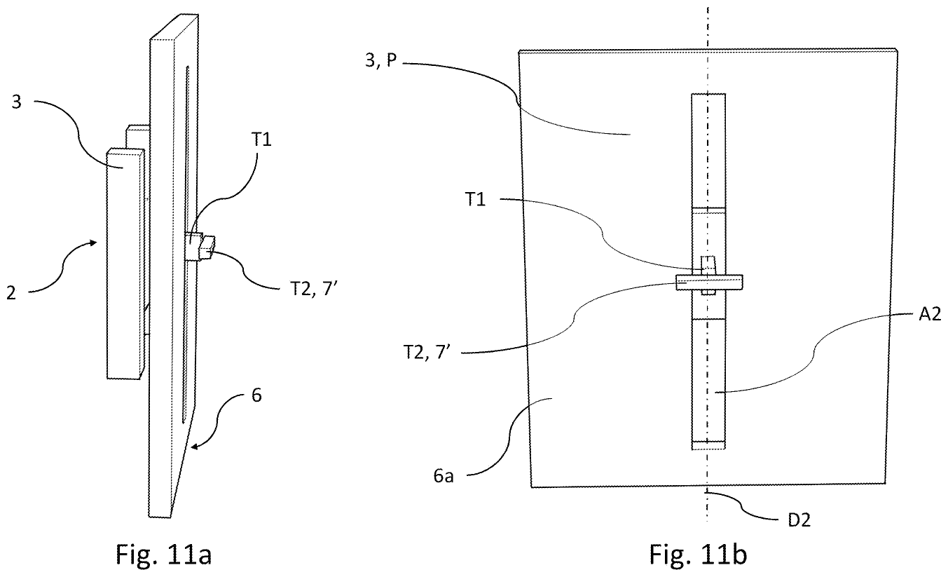

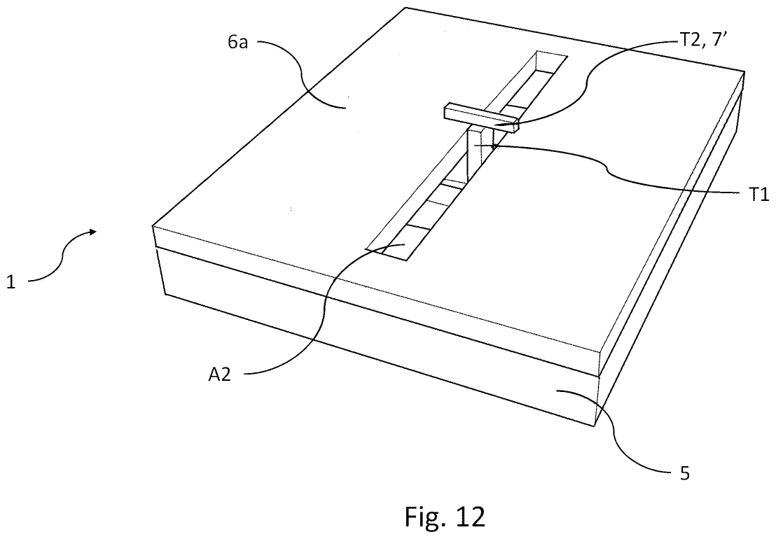

In this embodiment, the flexible main body 3 of the slider element 2 is subsequently orientable so that the second segment T2 of the actuator element 7 is transverse to the longitudinal extension direction D2 of the second through opening A2 of the second flexible sheet 6 to prevent the passage of the second segment T2 of the actuator element 7 through the second through opening A2 of the second flexible sheet 6 and so that the flexible main body 3 of the slider element 2 can slide inside the first through opening A1 of the first flexible sheet (FIGS. 11a, 11b and 12).

Referring now again to the first flexible sheet 5, in accordance with an embodiment, in combination with any of the previously described embodiments, the upper surface 5a and the lower surface 5b of the first flexible sheet 5 are adhesive.

In particular, the adhesive upper surface 5a and the adhesive lower surface 5b can be functionalized to have an adhesive functionality.

Furthermore, the adhesive upper surface 5a and lower surface 5b can be lined with a liner to be removed before use or be activated with heat and/or UV radiation.

In accordance with a further embodiment, shown in FIGS. 2b, 5b, 7b and alternative to the previous one, the electric switch 1 further comprises a first adhesive layer 8a attached to the upper surface 5a of the first flexible sheet 5 and a second adhesive layer 8b attached to the lower surface 5b of the first flexible sheet 5 associable with the surface 103 of the electrical system 100 on which the electric switch 1 is applicable.

The first adhesive layer 8a and the second adhesive layer 8b can be lined with a respective liner to be removed before use or be activated with heat and/or UV radiation.

In this embodiment, the lower surface 5b of the first flexible sheet 5 is associable with the surface 103 of the electrical system 100 on which the electric switch 1 is applicable by means of the second adhesive layer 8b.

The upper surface 5a of the first flexible sheet 5 is associable with the lower surface 6b of the second flexible sheet 6 by means of the first adhesive layer 8a.

In accordance with an embodiment, in combination with any of those described above, shown in FIGS. 8a and 8b, the electric switch 1 is associable with the surface 103 of the electrical system 100 so that said at least two electrical connections 104, 105 present on the surface 103 of the electrical system 100 on which the electric switch 1 is applicable are inside the first through opening A1 of the first flexible sheet 5 at the at least a first operating position P1 which the slider element 2 can assume inside the first through opening A1 of the first flexible sheet 5 along the longitudinal extension direction D1 of the first opening A1.

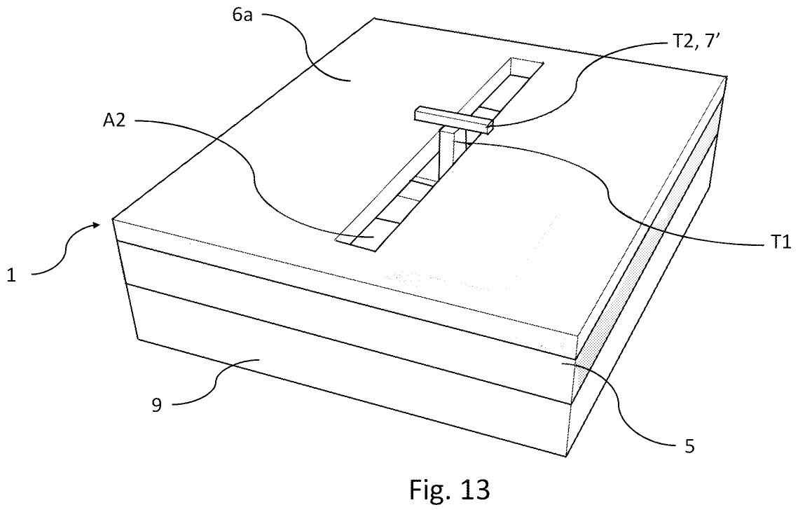

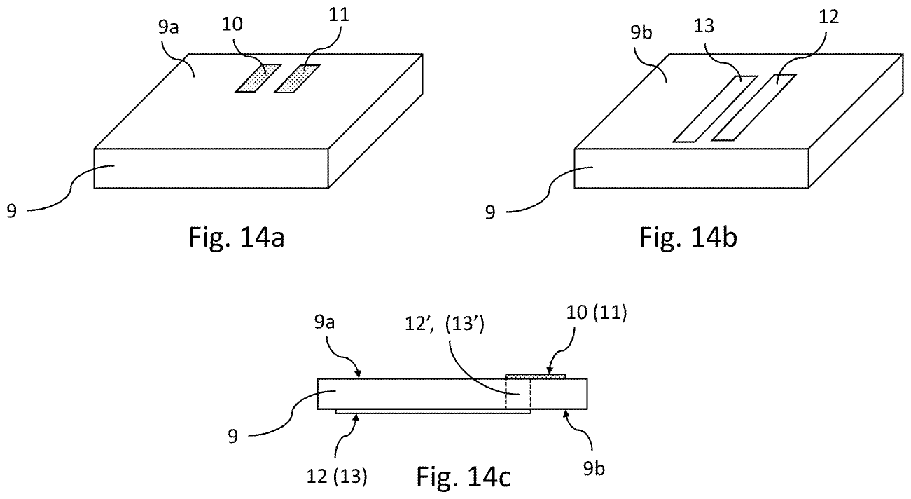

In accordance with an embodiment, as an alternative to the previous one and shown in FIGS. 13, 14a, 14b, 14c and 15, the electric switch 1 further comprises a flexible support substrate 9 of planar shape comprising a respective upper surface 9a and a respective lower surface 9b.

The flexible support substrate 9 can be made of plastic (for example, PET, PEN, Polyimide, Polycarbonate, and so on) or bioplastic (for example, polylactic acid) or paper or flexible material (for example, flexible glass).

The thickness of the flexible support substrate 9 can be in the range 1 micron-200 microns.

The upper surface 9a of the flexible support substrate 9 is operatively connected to the lower surface 5b of the first flexible sheet 5 of the electric switch 1 and the lower surface 9b of the flexible support substrate 9 is operatively connectable to the surface 103 of the electrical system 100 on which the electric switch 1 is applicable.

In this embodiment, the flexible support substrate 9 comprises at least two auxiliary electrical connections 10, 11 distributed on the upper surface 9a of the flexible support substrate 9 so as to be inside the first through opening A1 of the first flexible sheet 5 at the at least a first operating position P1 which the slider element 2 can assume inside the first through opening A1 of the first flexible sheet 5 along the longitudinal extension direction D1 of the first opening A1.

In this embodiment, the flexible support substrate 9 comprises at least two further auxiliary electrical connections 12, 13 distributed on the lower surface 9b of the flexible support substrate 9.

Each of said at least two further auxiliary electrical connections 12, 13 is electrically connected to one respective of said at least two auxiliary electrical connections 10, 11 by means of a respective vertical electrical connection 12′, 13′ (“hole”) obtained inside the flexible support substrate 9, for example by filling techniques with conductive inks and/or by sputtering techniques with metals.

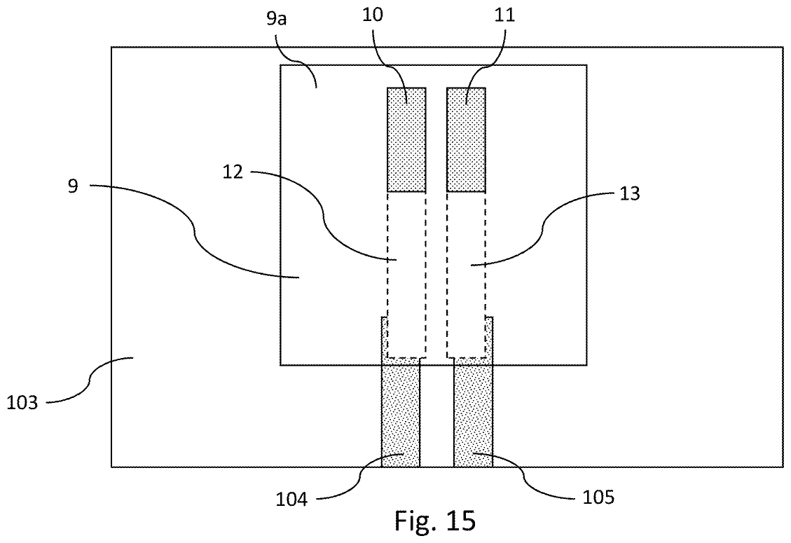

In this embodiment, the electric switch 1 is associable with the surface 103 of the electrical system 100 so that said at least two electrical connections 104, 105 present on the surface 103 of the electrical system 100 on which the electric switch 1 is applicable are each in electrical contact with one respective of said at least two further auxiliary electrical connections 12, 13 distributed on the lower surface 9b of the flexible support substrate 9 (FIG. 15).

In an embodiment, in combination with the previous one, the upper surface 9a and the lower surface 9b of the flexible support substrate 9 are adhesive.

In particular, the adhesive upper surface 9a and the adhesive lower surface 9b can be functionalized to have an adhesive functionality.

Furthermore, the adhesive upper surface 9a and adhesive lower surface 9b can be lined with a liner to be removed before use or be activated with heat and/or UV radiation.

In accordance with a further embodiment, not shown in the figures and in combination with any of those described above, the electric switch 1 can comprise locking mechanisms of the slider element 2 in the at least a first operating position P1 and in the at least a second operative position P2.

Thereby, the slider element 2 will be capable of maintaining the respective operating position even in the event of disturbances (for example, stress or vibrations) to which the electric switch 1 and/or the electrical system 100 could be subjected.

In an embodiment, in combination with the previous one, a locking mechanism can comprise friction elements, for example by modeling adhesive material, arranged around the first through opening A1 of the first flexible sheet at the at least a first operating position P1 and at the at least a second operating position P2.

In a further embodiment, alternatively or in combination with the previous one, a locking mechanism can consist of a set configuration of the shape of the first through opening A1 of the first flexible sheet 5 inside which the slider element 2 is adapted to slide and/or of the second through opening A2 of the second flexible sheet 6 inside which the actuator element 7 of the slider element 2 is adapted to slide and/or in a set configuration of the shape of the flexible main body 3 of the slider element 2.

In an embodiment, not shown in the drawings and in combination with any of those described above, the slider element 2 is adapted to slide inside the first through opening A1 of the first flexible sheet 5 along the longitudinal extension direction D1 of the first through opening A1 to assume a plurality of operating positions.

Each operating position corresponds to a state of the electric switch 1, including the switching-on state (ON) and the switching-off state (OFF).

In this embodiment, the electric switch 1 can comprise locking mechanisms of the slider element 2 in each operating position of said plurality of operating positions.

Examples of such locking mechanisms have been described above.

In some embodiments, already mentioned above, the components of the electric switch 1 can have the following features suitable for obtaining particular features:
the flexible sheets, the flexible main body and the possible flexible support substrate can consist of polymers and/or plastics and/or organic materials such as PET, PEN, Polyimide, paper.

In some embodiments, such components can consist of flexible materials such as flexible glass.

In other embodiments, such components can consist of bioplastics, for example Polylactic Acid.

The flexibility features of such components are also dependent on the thickness thereof.

The electric switch 1 object of the present invention can be made with flexible components having a thickness from 1 micrometer up to 200 micrometers, according to the bending specifications required by the application and according to the sustainable production cost thereof.

The electric switch 1 has shape properties, such as the possibility of being wrapped around objects with complex curvatures, such that it can be curved with a radius of curvature of 10 cm, below 10 cm, below 1 cm according to the application specification.

The electric switch 1 as a whole, or part thereof, can be combined with an overlapping layer and covered with specific additional graphics, so as to clarify the functions activated or deactivated by the change of state of the electric switch 1.

Such a layer containing the graphics can be produced directly on the electric switch 1 or produced separately and then applied with an appropriate method.

The adhesive layers present in the electric switch 1 can be made not only through the use of a glue or adhesive material, but also, for example, through the following principles or combinations thereof: electrostatic adhesion, chemical adhesion, adhesion with polymer nanobrushes.

This type of electric switch, and in particular the deposition and geometric definition of the conductive/insulating parts or of the adhesive parts, can be obtained with graphic printing technologies.

A graphic printing technology allows obtaining certain parts of the electric switch in a thin and superficial layer on a flexible sheet or on a chosen flexible support substrate, depositing the materials through printing methodologies (for example, ink jet) in the form of liquid inks, which are subsequently dried by removing the liquid part needed only for processing.

Such materials can include, but are not limited to, conductive polymers (e.g., PEDOT:PSS (poly(3,4-ethylenedioxythiophene) polystyrene sulfonate)), conductive metal inks (e.g., inks containing Ag or Cu nanoparticles, metal-organic complexes, metal “nanowires” or “nanorods”), conductors based on carbon derivatives (e.g., carbon nanotubes, graphene), conductive or insulating metal oxides, small organic molecules (e.g., PCBM, [6,6]-phenyl-C₆₁-butyric methyl ester), dielectric polymers (e.g., Polymethylmethacrylate (PMMA), Polystyrene).

With reference now to FIGS. 8a and 8b, an example of operation of a thin-film electric switch 1 is now described, in accordance with an embodiment of the invention.

The electric switch 1 is fixed to a surface 103 of an electrical system 100 comprising an electronic circuitry 101 and an electrical power supply module 102 (e.g., a battery).

The electrical system 100 further comprises two electrical connections 104, 105 separated from each other, the electrical connection of which allows the electronic circuitry 101 to be electrically connected to the power supply module 102, thus switching on the electrical system 100.

The electric switch 1 is fixed to the surface 103 of the electrical system so that the two ends of the electrical connections 104, 105 are inside the first through opening A1 of the first flexible sheet 5 of the electric switch 1 at the first operating position P1 which the slider element 2 can assume inside the first through opening A1 of the first flexible sheet 5.

As shown in FIG. 8a, the slider element 2 of the electric switch 1 is in the second operating position P2 which it can assume inside the first through opening A1 of the first flexible sheet 5, thus the two electrical connections 104, 105 are not electrically connected to each other (the electric switch 1 is in the switched-off or OFF state and the electrical system is off).

A user actuates the actuator element 7 of the electric switch 1 and slides the slider element 2 inside the first through opening A1 of the first flexible sheet 5 along the longitudinal extension direction D1 of the first through opening A1 of the first flexible sheet 5 until reaching the first operating position P1 of the slider element 2 in which the at least one portion 4 of conductive material of the slider element 2 electrically connects the two electrical connections 104, 105 of the system 100.

In this switching-on or ON state of the electric switch 1, the system 100 is on since the electronic circuitry 101 is electrically connected to the electric power supply module 102.

As can be seen, the object of the present invention is fully achieved.

In fact, the thin-film electric switch 1 object of the present invention comprises functional components present in the form of a thin film (in some implementations, less than a micrometer thick) and made of intrinsically flexible materials (for example plastics).

Such thin-film components have excellent mechanical flexibility properties which allow the electric switch 1 to bend with less possibility of damage or breakage of said layers.

Manufacturing and assembly techniques can be based on rotary processes, facilitating large-scale production volumes.

The electric switch 1 is designed so as to be easily integrated and with production processes suitable for high volumes (for example not requiring the use of pick-and-place machines).

In an exemplary implementation, such a feature is obtained through the integration of appropriately positioned adhesive surfaces.

The electric switch 1 is made entirely of flexible materials and components and is suitable for use, possibly in combination with flexible electronic systems, for applications in which such systems are applied on curved surfaces and/or with unconventional shape factors.

Some of these fields of application include: “printed electronics”, “flexible electronics”, “flexible PCB”, “wearable electronics”, “smart labels”, “biomedical electronics”.

For the market of these electric switches, needs and limitations may exist, even stringent ones, of an economic nature related to the costs for the addition of electric switch devices of the existing types.

For example, in some cases, the cost of assembling existing switches may form an unacceptable increase in the final product manufacturing cost.

The electric switch 1 object of the present invention is implemented so as to overcome these limitations.

In an implementation, this electric switch can be advantageously added to existing systems in the form of an “add-on”.

In order to meet contingent needs, those skilled in the art may modify and adapt the embodiments of the electric switch described above, and replace elements with others which are functionally equivalent, without departing from the scope of the following claims. All the features described above as belonging to a possible embodiment may be implemented irrespective of the other embodiments described.

What is claimed is:

1. A thin-film electric switch applicable to a surface of an electrical system comprising at least two electrical connections electrically connectable to each other, the thin-film electric switch comprising:
a slider element comprising a flexible main body of planar shape, said flexible main body comprising an upper surface and a lower surface, said flexible main body comprising at least one portion of conductive material extending on the lower surface;
a first flexible sheet of planar shape having a respective upper surface and a respective lower surface the lower surface of the first flexible sheet being associable with the surface of the electrical system on which the thin-film electric switch is applicable, the first flexible sheet comprising a first through opening having a respective longitudinal extension direction, the first through opening being adapted to define a housing for the flexible main body of the slider element having a shape that allows the flexible main body of the slider element to slide therein along the longitudinal extension direction of said first through opening;
a second flexible sheet of planar shape having a respective upper surface and a respective lower surface, the lower surface of the second flexible sheet being associable with the upper surface of the first flexible sheet, the second flexible sheet comprising a second through opening having a respective longitudinal extension direction parallel to the longitudinal extension direction of the first through opening,
the second flexible sheet being positioned on the first flexible sheet so as to at least partially overlap the first through opening and retain the flexible main body of the slider element inside the first through opening between the surface of the electrical system on which the thin-film electric switch is applicable and the lower surface of the second flexible layer, the slider element being adapted to slide inside the first through opening of the first flexible sheet along the longitudinal extension direction of the first through opening to assume at least one first operating position in which the at least one portion of conductive material of the flexible main body of the slider element electrically connects the at least two electrical connections to each other present on the surface of the electrical system on which the thin-film electric switch is applicable and at least one second operating position in which the at least one portion of conductive material of the flexible main body of the slider element does not connect said at least two electrical connections to each other present on the surface of the electrical system on which the thin-film electric switch is applicable.

2. The thin-film electric switch of claim 1, wherein said flexible main body of the slider element has a shape such as to be housed inside the housing defined by the first through opening of the first flexible sheet and slide along the longitudinal extension direction of the first through opening of the first flexible sheet.

3. The thin-film electric switch of claim 1, wherein said flexible main body of the slider element has a shape such as to force and orient the flexible main body of the slider element inside the housing defined by the first through opening of the first flexible sheet.

4. The thin-film electric switch of claim 1, wherein the slider element further comprises an actuator element operatively connected to the flexible main body extending therefrom along a direction substantially orthogonal to a reference plane on which the flexible main body extends, through the first through opening of the first flexible sheet and the second through opening of the second flexible sheet so that a free end of said actuator element is accessible from outside of the thin-film electric switch to allow, through an interaction with the actuator element, sliding of the slider element along the longitudinal extension direction of the first through opening of the first flexible sheet.

5. The thin-film electric switch of claim 4, wherein the actuator element is distinct from the flexible main body of the slider element, the actuator element being operatively connected to the flexible main body of the slider element by gluing.

6. The thin-film electric switch of claim 4, wherein the actuator element is in one piece with the flexible main body of the slider element, the actuator element being obtained starting from the flexible main body of the slider element by cutting and bending.

7. The thin-film electric switch of claim 1, wherein the flexible main body is made of plastic material and the at least one portion of conductive material extending on the lower surface of the flexible main body is the lower surface of the flexible main body.

8. The thin-film electric switch of claim 7, wherein the flexible main body is made of plastic or bioplastic material, paper, or flexible material and the at least one portion of conductive material extending on the lower surface of the flexible main body is a sheet of conductive material attached to the lower surface of the flexible main body.

9. The thin-film electric switch of claim 1, wherein the flexible main body is made of plastic or bioplastic material, paper, or flexible material and the at least one portion of conductive material extending on the lower surface of the flexible main body is at least one area of conductive material distributed on the lower surface of the flexible main body.

10. The thin-film electric switch of claim 1, wherein the entire flexible main body of the slider element is made of conductive material.

11. The thin-film electric switch of claim 4, wherein the actuator element of the slider element has a substantially T-like shape comprising a first segment substantially orthogonal to the reference plane on which the thin-film flexible main body of the slider element extends and a second segment, corresponding to the free end of the actuator element, transverse with respect to the first segment, the flexible main body of the slider element being orientable so that the second segment of the actuator element is parallel to the longitudinal extension direction of the second through opening of the second flexible sheet to allow a passage of the second segment of the actuator element through the second through opening of the second flexible sheet, the flexible main body of the slider element being subsequently orientable so that the second segment of the actuator element is transverse to the longitudinal extension direction of the second through opening of the second flexible sheet to prevent the passage of the second segment of the actuator element through the second through opening of the second flexible sheet and so that the flexible main body of the slider element is slidable inside the first through opening of the first flexible sheet.

12. The thin-film electric switch of claim 1, wherein the upper surface and the lower surface of the first flexible sheet are adhesive.

13. The thin-film electric switch of claim 1, further comprising a first adhesive layer attached to the upper surface of the first flexible sheet and a second adhesive layer attached to the lower surface of the first flexible sheet associable to the surface of the electrical system on which the thin-film electric switch is applicable, the lower surface of the first flexible sheet being associable to the surface of the electrical system on which the thin-film electric switch is applicable by the second adhesive layer, the upper surface of the first flexible sheet being associable with the lower surface of the second flexible sheet by the first adhesive layer.

14. The thin-film electric switch of claim 1, wherein said thin-film electric switch is associable with the surface of the electrical system so that said at least two electrical connections on the surface of the electrical system on which the thin-film electric switch is applicable are inside the first through opening of the first flexible sheet at the at least one first operating position that the slider element can assume inside the first through opening of the first flexible sheet along the longitudinal extension direction of the first through opening.

15. The thin-film electric switch of claim 1, further comprising a flexible support substrate of planar shape comprising a respective upper surface and a respective lower surface, the upper surface of the flexible support substrate being operatively connected to the lower surface of the first flexible sheet of the thin-film electric switch and the lower surface of the flexible support substrate being operatively connectable to the surface of the electrical system on which the thin-film electric switch is applicable,
the flexible support substrate comprising at least two auxiliary electrical connections distributed on the upper surface of the flexible support substrate so that the at least two auxiliary electrical connections are inside the first through opening of the first flexible sheet at the at least one first operating position that the slider element can assume inside the first through opening of the first flexible sheet along the longitudinal extension direction of the first through opening,
the flexible support substrate comprising at least two further auxiliary electrical connections distributed on the lower surface of the flexible support substrate, each of said at least two further auxiliary electrical connections being electrically connected to one respective of said at least two auxiliary electrical connections by a respective vertical electrical connection formed inside the flexible support substrate,
the thin-film electric switch being associable to the surface of the electrical system so that said at least two electrical connections on the surface of the electrical system on which the thin-film electric switch is applicable are each in electrical contact with one respective of said at least two further auxiliary electrical connections distributed on the lower surface of the flexible support substrate.
